(19) United States
(12) Patent Application Publication
(10) Pub. No.: US 2007/0027687 A1
(43) Pub. Date: Feb. 1, 2007

(54) Automatic donor ranking and selection system and method for voice conversion

(75) Inventors: Oytun Turk, Istanbul (TR); Levent Mustafa Arslan, Istanbul (TR); Fred Deutsch, New York, NY (US)

Correspondence Address: PAUL, HASTINGS, JANOFSKY & WALKER LLP, P.O. BOX 919092, SAN DIEGO, CA, 92191-9092, US

(73) Assignee: Voxonic, Inc., New York, NY (US)

(21) Appl. No.: 11/376,377

(22) Filed: Mar. 14, 2006

Related U.S. Application Data
(60) Provisional application No. 60/661,802, filed on Mar. 14, 2005.

(51) Int. Cl. G10L 17/00

(52) U.S. Cl. 704/246

(57) ABSTRACT

An automatic donor selection algorithm estimates the subjective voice conversion output quality from a set of objective distance measures between the source and target speaker's acoustical features. The algorithm learns the relationship of the subjective scores and the objective distance measures through nonlinear regression with an MLP. Once the MLP is trained, the algorithm can be used in the selection or ranking of a set of source speakers in terms of the expected output quality for transformations to a specific target voice.

### CROSS-REFERENCE TO RELATED APPLICATION

The present patent application claims priority to U.S. Provisional Patent Application No. 60/661,802, filed Mar. 14, 2005, and entitled “Donor Selection For Voice Conversion,” the entire disclosure of which is incorporated by reference herein.

### BACKGROUND OF THE INVENTION

1. Field of Invention

This invention relates to the field of speech processing and more specifically, to a technique for selecting a donor speaker for a voice conversion process.

2. Description of Related Art

Voice conversion is aimed at the automatic transformation of a source (i.e., donor) speaker's voice to a target speaker's voice. Although several algorithms are proposed for this purpose, none of them can guarantee equivalent performance for different donor-target speaker pairs.

The dependence of voice conversion performance on the donor-target speaker pairs is a disadvantage for practical applications. However, in most cases, the target speaker is fixed, i.e., the voice conversion application aims to generate the voice of a specific target speaker and the donor speaker can be selected from a set of candidates. As an example, consider a dubbing application that involves the transformation of an ordinary voice to a celebrity's voice in, for example, a computer game application. Rather than using the actual celebrity to record a soundtrack, which may be expensive or not available, a speech conversion system is used to convert an ordinary person's speech (i.e., a donor's speech) to speech sounding like that of the celebrity. In this case, choosing the best suited donor speaker among a set of donor candidates, i.e., available people, enhances the output quality significantly. For example, speech from a female Romantic speaker may be better suited as a donor voice in a particular application than speech from a male Germanic speaker. However, it is time-consuming and expensive to collect an entire training database from all possible candidates, perform appropriate conversions for each possible candidate, compare the conversions to each other, and obtain the subjective decisions of one or more listeners on the output quality or suitability of each candidate.

### SUMMARY OF THE INVENTION

The present invention overcomes these and other deficiencies of the prior art by providing a donor selection system for automatically evaluating and selecting a suitable donor speaker from a group of donor candidates for conversion to a given target speaker. Particularly, the present invention employs, among other things, objective criteria in the selection process by comparing acoustical features obtained from a number of donor and target utterances without actually performing speech conversions. Certain relationships between the objective criteria and the output quality enable selection of the best donor candidate. Such a system eliminates, among other things, the need to convert large amounts of speech and to have a panel of humans subjectively listen to the conversion quality.

In an embodiment of the invention, a system for ranking donors comprises an acoustical feature extractor, which extracts acoustical features from donor speech samples and target speaker speech samples, and an adaptive system which generates a prediction for voice conversion quality based on the extracted acoustical features. Where the voice conversion quality can be based on the overall quality of the conversion and on the similarity of the converted speech to the vocal characteristics of the target speaker. The acoustical features can include features such as the line spectral frequency (LSF) distance, the pitch, phoneme duration, word duration, utterance duration, inter-word silence duration, energy, spectral tilt, jitter, open quotient, shimmer, and electro-glottograph (EGG) shape values.

In another embodiment, a system for selecting a suitable donor for a target speaker employs a donor ranking system and selects a donor based on the results of the ranking.

In another embodiment, a method for ranking a donor comprises the steps of: extracting one or more acoustical features and predicting voice conversion quality based on the acoustical features using an adaptive system.

In yet another embodiment, a method for training a donor ranking system comprises the steps of selecting a donor and a target speaker from a training database of speech samples, deriving a subjective quality value, extracting one or more acoustical features from a donor voice speech sample and a target speaker voice speech sample, supplying the acoustical features to an adaptive system, predicting a quality value using the adaptive system, calculating the error between the predicted quality value and the subjective quality value and adjusting the adaptive system based on the error. Furthermore, the subjective quality value can be obtained by converting the donor voice speech sample to a converted voice speech sample having the vocal characteristics of the target speaker, providing both the converted voice speech sample and the target speaker voice speech sample to one or more subjective listeners, and receiving the subjective quality value from the subjective listeners. Where the subjective quality values can be a statistical combination of individual subjective quality values obtained from each of the subjective listeners.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an automatic donor ranking system according to an embodiment of the invention;

FIG. 2 illustrates a process implemented by feature extractor to extract a set of acoustical features from a given speech sample according to an embodiment of the invention;

FIG. 3 illustrates an Open Quotient estimation from an EGG recording of an exemplary male speaker according to an embodiment of the invention;

FIG. 4 illustrates an EGG shape characterizing one period of the EGG signals for an exemplary male speaker according to an embodiment of the invention;

FIG. 5 illustrates exemplary histograms of different acoustical features for an exemplary female to female voice conversion according to an embodiment of the invention;

FIG. 6 illustrates an adaptive system comprising a multi-layer perceptron (MLP) network according to an embodiment of the invention;

FIG. 7 illustrates the automatic donor ranking system when configured during training according to an embodiment of the invention;

FIG. 8 illustrates a method of generating a training set according to an embodiment of the invention;

FIGS. 9 and 10 illustrate tables listing the average S-scores for all source-target speaker pairs according to experiment;

FIGS. 11 and 12 illustrate tables listing the average Q-scores for all source-target speaker pairs according to the experiment; and

FIG. 13 illustrates results for 10-fold cross-validation and testing the MLP based automatic donor selection algorithm according to an embodiment of the invention.

### DETAILED DESCRIPTION OF EMBODIMENTS

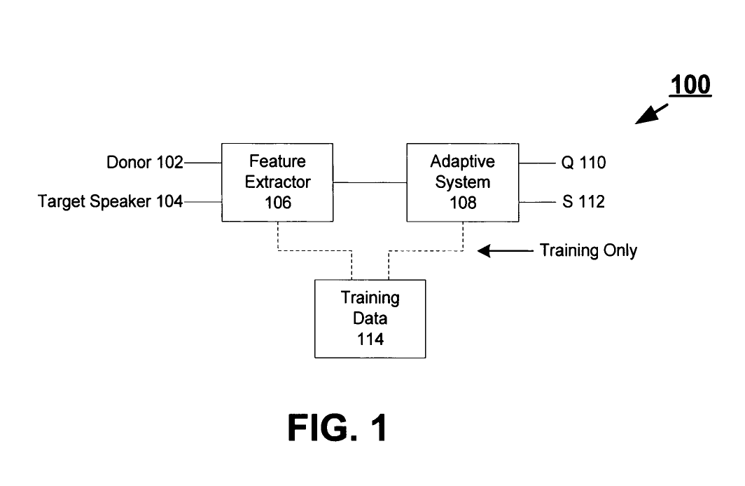

Further features and advantages of the invention, as well as the structure and operation of various embodiments of the invention, are described in detail below with reference to the accompanying FIGS. 1-13, wherein like reference numerals refer to like elements. The embodiments of the invention are described in the context of a voice conversion system. Nonetheless, one of ordinary skill in the art readily recognizes that the present invention and features thereof described herein are applicable to any speech processing system where donor voice selection is required or may enhance conversion quality.

In many speech conversion applications such as movie dubbing, a dubbing actor's voice is converted to that of the feature actor's voice. In such an application, speech recorded by a source (donor) speaker such as a dubbing actor is converted to a vocal tract having the voice characteristics of a target speaker such as a feature actor. For example, a movie may be dubbed from English to Spanish with the desire to maintain the vocal characteristics of the original English actor's voice in the Spanish soundtrack. In such an application, the vocal characteristics of the target speaker (i.e., English actor) are fixed, but there is a pool of donors (i.e., Spanish speakers) with a wide variety of vocal characteristics available to contribute to the dubbing process. Some donors yield better conversions than others in terms of overall sound quality and similarity to the target speaker.

Traditionally, donors are evaluated by converting samples of speech to the vocal characteristics of a target speaker, and then subjectively comparing each converted sample to a sample of the target speaker. In other words, one or more persons must intervene and decide upon listening to all conversion which particular donor is best suited. In a movie dubbing scenarios, this process has to be repeated for each target speaker and each set of donors.

In contrast, the present invention provides an automatic donor ranking and selection system and requires only a target speaker sample and one or more donor speaker samples. An objective score is calculated to predict the likelihood that a given donor would yield a quality conversion based on a plurality of acoustical features without the costly step of converting any of the donor speech samples.

The automatic donor ranking system comprises an adaptive system which uses key acoustical features to evaluate the quality of a given donor for conversion to a given target speaker's voice. Before the automatic donor ranking system can be used to evaluate the donor, the adaptive system is trained. During this training process, the adaptive system is supplied with a training set, which is derived from exemplary speech samples from a plurality of speakers. A plurality of donor-target speaker pairs is derived from the plurality of speakers. Initially, subjective quality scores are then derived when the donor speech is converted to the vocal characteristics of the target speaker and evaluated by one or more humans. Though some amount of conversion is performed in training the adaptive system, once trained, the automatic donor system does not require any additional voice conversion.

FIG. 1 illustrates an automatic donor ranking system 100 according to an embodiment of the invention. A donor speech sample 102 and a target speaker speech sample 104 are fed into an acoustical feature extractor 106, the implementation of which is apparent to one of ordinary skill in the art, to extract acoustical features from the donor speech sample 102 and the target speaker speech sample 104. These acoustical features are then supplied to an adaptive system 108, which generates a Q-score output 110 and an S-score output 112. The Q-score output 110 is the predicted Mean Opinion Scale (MOS) sound quality of a voice conversion from the donor's voice to the target voice, which corresponds to the standard MOS scale for sound quality: 1=Bad, 2=Poor, 3=Fair, 4=Good, 5=Excellent. The S output 112 is the predicted similarity of a voice conversion from the donor's voice to the target voice, as ranked from 1=Bad to 10=Excellent. During the training process of adaptive system 108 described below, a training set 114 is supplied to the acoustical feature extractor 106, processed by the adaptive system 108. The training set comprises a plurality of donor-target speaker pairs along with a Q-score and an S-score. For each donor-target speaker pair, acoustical feature extractor 106 extracts the acoustical features from the donor speech and the target speaker speech and supplies the result to the adaptive signal, which calculates and supplied Q-score output 110 and the S-score output 112. The Q-score and S-score for the donor-target speaker pair from the training set is supplied to adaptive system 108 which compares it with Q-score output 110 and S-score output 112. Adaptive system 108 then adapts to minimize the discrepancy between the generated Q-score and S-score with the Q-score and S-score in the training set.

For any given target speaker, if a plurality of donor vocal tracts are available to the system 100, the resultant respective values of the Q-score output 110 and S-score output 112 indicates which donor of the plurality of donors is likely to yield a higher quality voice conversion both in the similarity of the converted voice to the target speaker's voice and the general sound quality of the converted voice.

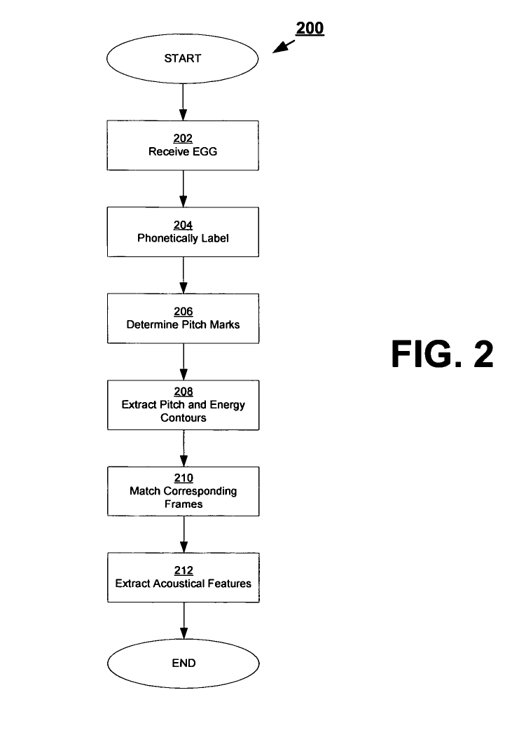

FIG. 2 illustrates a process 200 implemented by feature extractor 106 to extract a set of acoustical features from a given speech sample, i.e., vocal tract, according to an embodiment of the invention. At step 202, each sample is received as an electro-glottograph (EGG) recording. An EGG recording gives the volume velocity of air at the output of the organ glottis (vocal folds) as an electrical signal. It shows the excitation characteristics of the person during the utterance of speech. At step 204, each sample is phonetically labeled by, for example, a Hidden Markov Model Toolkit (HTK), the implementation of which is apparent to one of ordinary skill in the art. At step 206, the EGG signals of sustained vowel /aa/ are analyzed and pitch marks are determined. The /aa/ sound is used because for the /aa/ sound, no constriction is applied at any point on the vocal tract, therefore it is a good reference for comparison of source and target speaker excitation characteristics, while for the production of other sounds, an accent or dialect may impose additional variability. At step 208, pitch and energy contours are extracted. At step 210, corresponding frames are determined between each source and target utterance from the phonetic labels. At step 212, individual acoustical features are extracted.

In an embodiment of the invention, the individual acoustical features extracted include one or more of the following features: line spectral frequency (LSF) distances, pitch, duration, energy, spectral tilt, open quotient (O), jitter, shimmer, soft phonation index (SPI), H1-H2, and EGG shape. These features are described below in greater detail.

Specifically, in an embodiment of the invention, LSFs are computed on a frame-by-frame basis using a linear prediction order of 20 at 16 KHz. The distance, d, between two LSF vectors is computed using

$$d = {\sum }_{k = 1}^{P} {h}_{k} \vert {w}_{1 k} - {w}_{2 k} \vert$$

$$where$$

$${h}_{k} = \frac{1}{arg min ( \vert {w}_{k} - {w}_{k - 1} \vert , \vert {w}_{k} - {w}_{k - 1} \vert )} for k = 1 , … , P$$

where wₗₖ is the k^{th} entry of the first LSF vector, w₂ₖ is the k^{th} entry of the second LSF vector, P is the prediction order, and hₖ is the weight of the k^{th} entry corresponding to the first LSF vector.

Pitch (f₀) values are computed using a standard auto-correlation based pitch detection algorithm, the identification and implementation of which is apparent to one of ordinary skill in the art.

For duration features, phoneme, word, utterance, and inter-word silence durations are calculated from the phonetic labels.

For energy features, a frame-by-frame energy is computed.

For the spectral tilt, the slope of the least-squares line fit to the LP spectrum (prediction order 2) between the dB amplitude value of the global spectral peak and the dB amplitude value at 4 KHz is used.

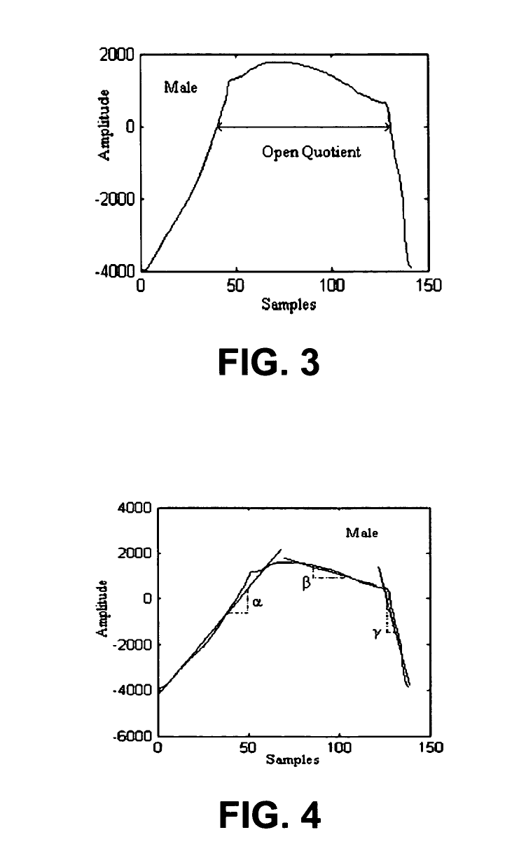

For each period of the EGG signals, the OQ is estimated as the ratio of the positive segment of the signal to the length of the signal as shown for an exemplary male speaker in FIG. 3.

Jitter is the average period-to-period variation of the fundamental pitch period, T₀, excluding unvoiced segments in the sustained vowel /aa/ is computed using

$$J = \frac{\frac{1}{N - 1} {\sum }_{i = 1}^{N - 1} \vert {T}_{0} ( i ) - {T}_{0} ( i + 1 ) \vert}{\frac{1}{N} {\sum }_{i = 1}^{N} {T}_{0} ( i )} .$$

Shimmer is the average period-to-period variation of the peak-to-peak amplitude, A, excluding unvoiced segments in the sustained vowel /aa/ is computed using

$$S = \frac{\frac{1}{N - 1} {\sum }_{i = 1}^{N - 1} \vert A ( i ) - A ( i + 1 ) \vert}{\frac{1}{N} {\sum }_{i = 1}^{N} A ( i )} .$$

Soft Phonation Index (SPI) is the average ratio of the lower-frequency harmonic energy in the range 70-1600 Hz to the harmonic energy in the range 1600-4500 Hz is computed.

H1-H2 is the frame-by-frame amplitude difference of the first and second harmonic in the spectrum as estimated from the power spectrum.

The EGG shape is a simple, three parameter model to characterize one period of the EGG signals as shown for an exemplary male speaker in FIG. 4, where α is the slope of the least-squares (LS) line fitted from the glottal closure instant to the peak of the EGG signal, β is the slope of the LS line fitted to the segment of the EGG signal when the vocal folds are open, and γ is the slope of the LS line fitted to the segment when the vocal folds are closing.

Unlike the LSF distance which yields a single value, all of the other features described above as extracted are distributions.

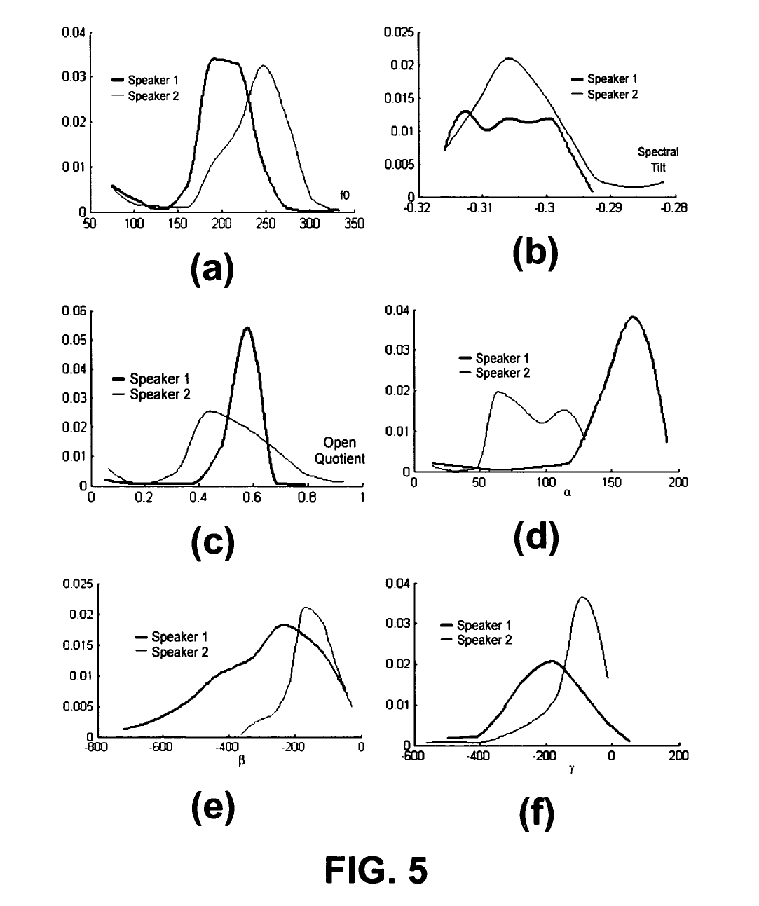

FIG. 5 illustrates exemplary histograms of different acoustical features for two exemplary females according to an embodiment of the invention. In these histograms, y-axis correspond to the normalized frequency of occurrence of the parameter values in the x-axis. Particularly, FIG. 5(a) illustrates the pitch distributions for the two females. FIG. 5(b) shows the spectral tilt for the two females. FIG. 5(c) illustrates the open quotient for these two females. FIGS. 5(d)-(f) illustrate their EGG shape, particularly the, β and γ parameters respectively. Temporal and spectral features such as those shown in FIG. 5 are speaker-dependent and can be used for analyzing or modeling differences among speakers. In an embodiment of the invention, a set of acoustic features listed above are used for modeling the differences between source-target speaker pairs.

In an embodiment of the invention, the acoustical feature distance between two speakers is calculated using, for example, a Wilcoxon rank-sum test, which is a conventional statistical method of comparing distributions. This rank-sum test is a nonparametric alternative to a two-sample t-test as described by Wild and Seber, and is valid for data from any distribution and is much less sensitive to the outliers as compared to the two-sample t-test. It reacts not only to the differences in the means of distributions but also to the differences between the shapes of the distributions. The lower the rank-sum value, the closer are the two distributions under comparison.

In an embodiment of the invention, one or more of the acoustical features noted above are provided as input into the adaptive system 108. Prior to using the adaptive system 108 to rank donors, it must undergo a training phase. Specifically, a training set 114 comprising a set of donor-target speaker pairs is provided along with their S and Q scores. Examples of deriving or observing data for to develop a training set is described below. Additionally, a set of donor-target speaker pairs with S and Q scores are reserved as a test set. During the training phase, each donor-target speaker pair has acoustical features extracted such as one or more of those described above by the acoustical feature extractor 106. These features are fed into the adaptive system 108, which produces a predicted S and Q score. These predicted scores are compared to the S and Q scores supplied as part of training set 114. The differences are supplied to the adaptive system 108 as its error. The adaptive system 108 then adjusts in an attempt to minimize its error. There are several methods for error minimization known in the art, specific examples are described below. After a period of training, the acoustical features of the donor-target speaker pairs in the test set are extracted. The adaptive system 108 produces a predicted S and Q score. These values are compared with the S and Q scores supplied as part of the test set. If the error between the predicted and actual S and Q scores is within an acceptable threshold, the adaptive system 108 is trained and ready for use. For example, when the error is within ±5% of the actual value. If not, the process returns to training.

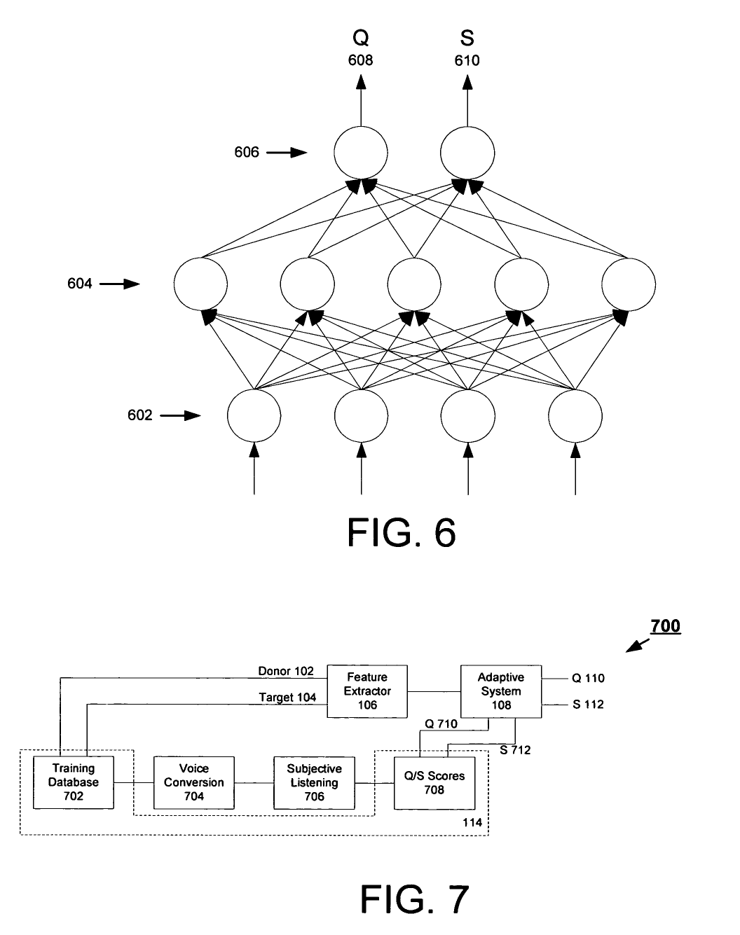

In at least one embodiment of the invention, the adaptive system 108 comprises a multi-layer perceptron (MLP) network or backpropagation network. FIG. 6 illustrates an example of an MLP network. It comprises an input layer 602 which receives the acoustical features, one or more hidden layers 604 which is coupled to the input layer, and an output layer 606 which generates the predicted Q and S outputs 608 and 610, respectively. Each layer comprises one or more perceptrons which have weights coupled to each input that can be adjusted in training. Techniques for building, training, and using MLP networks are well-known in the art (see, e.g., Neurocomputing, by R. Hecht-Nielsen, pp. 124-138, 1987). One such method of training a MLP network is the gradient descent method of error minimization, the implementation of which is apparent to one of ordinary skill in the art.

FIG. 7 illustrates the automatic donor ranking system 100 when configured during training according to an embodiment of the invention. During training, a training database 702 is provided with sample recordings of utterances of several speakers and forms a training set 114 with the addition of Q and S scores 708 for donor-target speaker pairs of recordings which are in the training database 702. To generate the Q and S scores 708, each possible donor-target speaker pair has the donor speech converted to mimic the vocal characteristics of the target speaker 704. Subjective listening criteria are initially applied to compare the converted speech and the target speaker speech 706. For example, human listeners may rate the perceived quality of each conversion. Note that this subjective listening test is only performed once initially during training. Subsequent perception analysis are objectively performed by the system 100.

Voice conversion element 704, which may be embodied as a hardware and/or software, should implement the same conversion method for which system 100 is designed to evaluate donor quality. For example, if system 100 is used to determine the best donor for a voice conversion using Speaker Transformation Algorithm using Segmental Codebooks (STASC), then STASC conversion should be used. However, if donors are to be selected for another voice conversion technique, such as the codebook-less technique disclosed in commonly owned U.S. patent application Ser. No. 11/370,682, entitled “Codebook-less Speech Conversion Method and System,” filed on Mar. 8, 2006, by Turk, et al., the entire disclosure of which is incorporated by reference herein, then voice conversion 704 should use that same voice conversion technique.

In the training process, a donor-target speaker pair is provided to the feature extractor 106, which extracts features used by the adaptive system 108 to predict a Q-score and an S-score as described above. In addition, an actual Q-score 710 and S-score 712 are provided to the adaptive system 108. Based on the specific training algorithm used, the adaptive system 108 adapts to minimize the error between the predicted and actual Q-scores and S-scores.

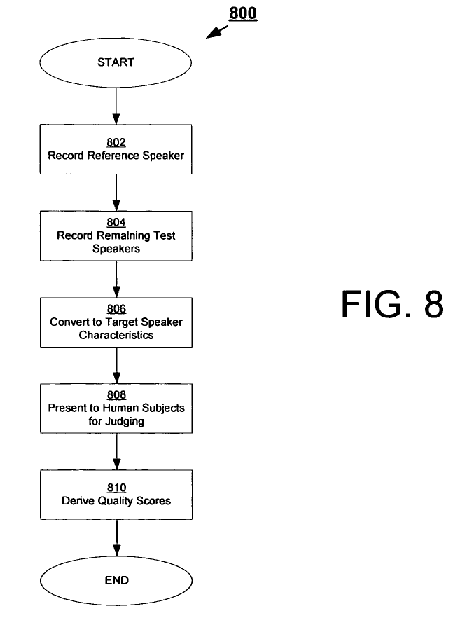

FIG. 8 illustrates a method 800 of generating a training set according to an embodiment of the invention. Particularly, at step 802, a test speaker is recorded uttering a predetermined a set of utterances. At step 804, the remaining test speakers are recorded uttering the same predetermined set of utterances and are told to mimic the first test speakers timing as closely as possible, which helps to improve automatic alignment performance. At step 806, for each pre-selected donor-target speaker pair, utterances of the donor are converted to the vocal characteristics of the target speaker. As noted above, if system 100 is used to determine the best donor for a voice conversion using STASC, then STASC conversion should be used at step 806. However, if donors are to be selected for another voice conversion technique, then the voice conversion at step 806 should use the same voice conversion technique.

Because differences in voice and recording qualities are very subjective, such as the Q and S values described above, the derivation of training and test data should be initially based on subjective testing. Accordingly, at step 808, one or more human subjects are presented with the source, target and transformed utterances and asked to provide two subjective scores for each transformation: similarity of the transformation output to the target speaker's voice (S score) and the MOS quality of the voice conversion output (Q score) using the scoring ranges noted above. At step 810, a representative score can be determined for the Q score and S score, such as using some form of statistical combination. For example, the average across all S scores and all Q scores for everyone in the group can be used. In another example, the average across all S scores and all Q scores for everyone in the group after the highest and lowest scores are thrown out can be used. In another example, the median of all S scores and all Q scores for everyone in the group can be used.

As an example of developing a training set, an experimental study is described below. For this example, STASC is used as a voice conversion technique, which is a codebook mapping based algorithm proposed in “Speaker transformation algorithm using segmental codebooks,” by L. M. Arslan, (Speech Communication 28, pp. 211-226, 1999). STASC employs adaptive smoothing of the transformation filter to reduce discontinuities and results in natural sounding and high quality output. STASC is a two-stage codebook mapping based algorithm. In the training stage of the STASC algorithm, the mapping between the source and target acoustical parameters is modeled. In the transformation stage of the STASC algorithm, the source speaker acoustical parameters are matched with the source speaker codebook entries on a frame-by-frame basis and the target acoustical parameters are estimated as a weighted average of the target codebook entries. The weighting algorithm reduces discontinuities significantly. It is being used in commercial applications for international dubbing, singing voice conversion, and creating new text-to-speech (TTS) voices.

Experimental Results

The following experimental study was used to generate a training set of 180 donor-target speaker pairs. First, a voice conversion database consisted of 20 utterances (18 training, 2 testing) from 10 male and 10 female native Turkish speakers recorded in an acoustically isolated room. The utterances were natural sentences describing the room like “There is a grey carpet on the floor.” The EGG recordings were collected simultaneously. One of the male speakers was selected as the reference speaker and the remaining speakers were told to mimic the timing of the reference speaker as closely as possible

Male-to-male and female-to-female conversions were considered separately in order to avoid quality reduction due to large amounts of pitch scaling required for inter-gender conversions. Each speaker was considered as the target and conversions were performed from the remaining nine speakers of the same gender to that target speaker. Therefore, the total number of source-target pairs was 180 (90 male-to-male, 90 female-to-female).

Twelve subjects were presented with the source, target, and transformed recording and were asked to provide two subjective scores for each transformation, the S score and the Q score.

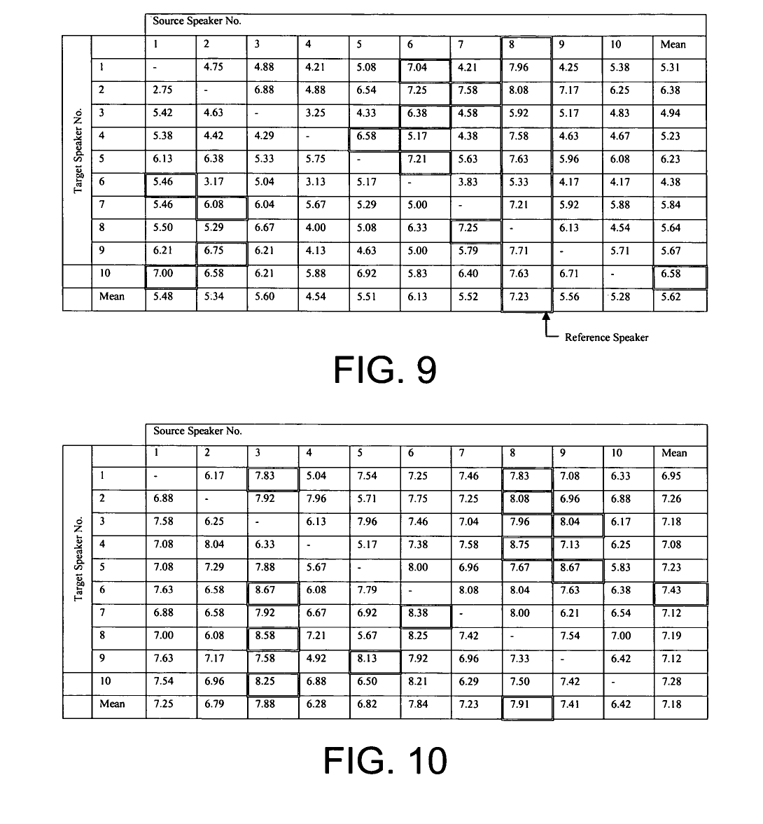

FIGS. 9 and 10 illustrate tables listing the average S-scores for all source-target speaker pairs according to the experiment. Particularly, FIG. 9 lists the average S-scores for all male source-target pairs and FIG. 10 lists the average S-scores for all female source-target pairs. For male pairs, highest S-scores are obtained when the reference speaker was the source speaker. Therefore, the performance of voice conversion is enhanced when the source timing matches the target timing better in the training set. Excluding the reference speaker, the source speaker that results in the best voice conversion performance varies as the target speaker varies. Therefore, the performance of the voice conversion algorithm is dependent on the specific source-target pair chosen. The last rows of the tables show that some source speakers are not appropriate for voice conversion as compared to others, e.g., male source speaker no. 4 and female source speaker no. 4. The last columns in the tables indicate that it is harder to generate the voice of specific target speakers, i.e., male target speaker no. 6 and female target speaker no. 1.

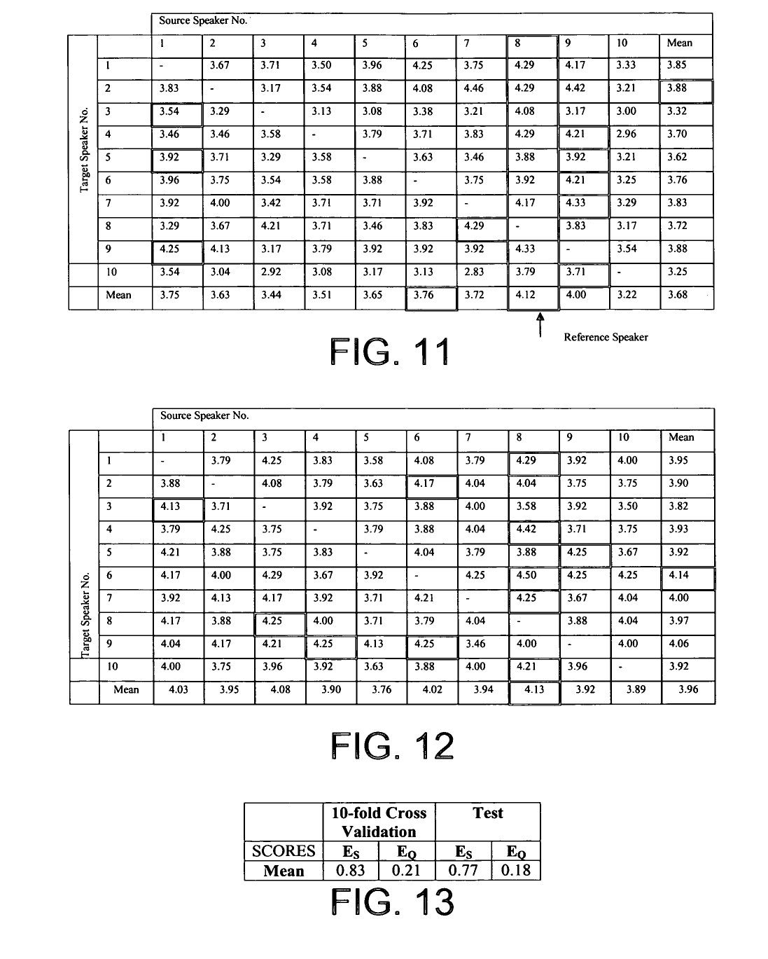

FIGS. 11 and 12 illustrate tables listing the average Q-scores for all source-target speaker pairs according to the experiment. Particularly, FIG. 11 lists the average Q-scores for all male source-target pairs and FIG. 12 lists the average S-scores for all female source-target pairs.

In an embodiment of the invention, after the training set was created as described above and system 100 was trained. The performance of system 100 in predicting the subjective test values were evaluated using 10-fold cross validation. For this purpose, two male and two female speakers are reserved as the test set. Two male and two female speakers are reserved as the validation set. The objective distances among the remaining male-male pairs and female-female pairs are used as the input to system 100 and the corresponding subjective scores as the output. After training, the subjective scores are estimated for the target speakers in the validation set and the error for the S-score and the Q-score is calculated.

FIG. 13 illustrates results for 10-fold cross-validation and testing the MLP based automatic donor selection algorithm according to an embodiment of the invention. The error on each cross-validation step is defined as the absolute difference between the system 100 decision and the subjective test results, where

$${E}_{Q} = \frac{1}{T} {\sum }_{i = 1}^{T} \vert {Q}_{SUB} ( i ) - {Q}_{MLP} ( i ) \vert$$

$$and$$

$${E}_{S} = \frac{1}{T} {\sum }_{i = 1}^{t} \vert {S}_{SUB} ( i ) - {S}_{MLP} ( i ) \vert ,$$

and where T is the total number of source-target pairs in the test, S_{SUB}(i) is the subjective S-score for the i^{th} pair, S_{MLP}(i) is the S-score estimated by the MLP for the i^{th} pair, Q_{SUB}(i) is the Q-score for the i^{th} pair, and Q_{MLP}(i) is the Q-score estimated by the MLP for the i^{th} pair. E_{S} denotes the error in the S-scores and EQ denotes the error in the Q-scores. The two steps described above are repeated 10 times by using different speakers in the validation set. The average cross-validation errors are computed as the average of the errors in the individual steps. Finally, the MLP is trained using all the speakers except the ones in the test set and the performance is evaluated on the test set.

Furthermore, decision trees can be trained with the ID3 algorithm to investigate the relationship between the subjective test results and the acoustical feature distances. In an experimental result, a decision tree trained with data from all source-target speaker pairs distinguishes male source speaker no. 3 from the others by using only H1-H2 characteristics. The low subjective scores obtained when he is used as a target speaker indicate that it is harder to generate this speaker's voice using voice conversion. This speaker had significantly lower H1-H2 and f₀ as compared to the rest of the speakers as correctly identified by the decision tree.

The system described above predicts the conversion quality based on a given donor. A donor can be selected from a plurality of donors for a voice conversion tasked based on the predicted Q score and S score. The relative importance of the Q and S score depends on the application. For example, in the example of motion picture dubbing, audio quality is very important, so a high Q score may be preferable even at the expense of similarity to the target speaker. In contrast, in a TTS system applied to voice response on a phone system where the environment might be noisy, such as a roadside assistance call center, the Q score is not as important, so the S score could be weighted more heavily in the donor selection process. Therefore in a donor selection system, donors from a plurality of donors are ranked using their Q-score and S-score and the best choice in terms Q-scores and S-scores is selected, where the relationship between the Q and S scores is formulated based on the specific application.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A donor ranking system comprising:
an acoustical feature extractor which extracts one or more acoustical features from a donor speech sample and a target speaker speech sample; and
an adaptive system which generates a prediction for a voice conversion quality value based on the acoustical features.

2. The system of claim 1, wherein the adaptive system is trained on a set of training data comprising a donor speech sample, a target speaker speech sample, and an actual voice conversion quality value.

3. The system of claim 1, wherein the voice conversion quality value comprises a subjective ranking of the similarity of a transformed speech sample derived from the donor speech sample and the target speaker speech sample.

4. The system of claim 1, wherein the voice conversion quality value comprises a MOS quality value.

5. The system of claim 1, wherein the one or more acoustical features are selected from a group consisting of LSF distance, the rank-sum of a duration distribution, the rank-sum of a pitch distribution, the rank-sum of an energy distribution comprising a plurality of frame-by-frame energy values, the rank-sum of a distribution of spectral tilt values, the rank sum of a distribution of per period open quotient values of an EGG signal period, the rank-sum of a distribution of period-to-period jitter value, the rank-sum of a distribution of period to period shimmer value, the rank-sum of a distribution of soft phonation indices, the rank sum of a distribution of frame-by frame amplitude differences between first and second harmonics, the rank sum of a distribution of a period-by-period EGG shape value, and a combination thereof.

6. The system of claim 5, wherein the duration distribution comprises a duration feature from a group consisting of phoneme duration, word duration, utterance duration, and inter-word silence duration.

7. The system of claim 5, wherein the EGG shape value for a period is a slope of a least-squares fitted line from a group consisting of the segment between a glottal closure instant to a maximum value of the period, the segment of the EGG signal when the vocal folds are open, and the segment when the vocal folds are closing.

8. A donor selection system comprising the donor ranking system of claim 1, wherein a plurality of speech samples from a plurality of donors is paired with the target speech sample and a donor is selected from the plurality of donors based on the prediction for each of the plurality of speech samples.

9. A method for ranking donors comprising:
extracting one or more acoustical features from features from a donor speech sample and a target speaker speech sample; and
predicting for a voice conversion quality value based on the acoustical features using a trained adaptive system

10. The method of claim 9, wherein the adaptive system is trained on a set of training data comprising a donor speech sample, a target speaker speech sample, and an actual voice conversion quality value.

11. The method of claim 9, wherein the voice conversion quality value comprises a subjective ranking of the similarity of a transformed speech sample derived from the donor speech sample and the target speaker speech sample.

12. The method of claim 9, wherein the voice conversion quality value comprises a MOS quality value.

13. The method of claim 9, wherein the one or more acoustical features are selected from a group consisting of LSF distance, the rank-sum of a duration distribution, the rank-sum of a pitch distribution, the rank-sum of an energy distribution comprising a plurality of frame-by-frame energy values, the rank-sum of a distribution of spectral tilt values, the rank sum of a distribution of per period open quotient values of an EGG signal period, the rank-sum of a distribution of period-to-period jitter value, the rank-sum of a distribution of period-to period shimmer value, the rank-sum of a distribution of soft phonation indices, the rank sum of a distribution of frame-by frame amplitude differences between first and second harmonics, the rank sum of a distribution of a period-by-period EGG shape value, and a combination thereof.

14. The method of claim 13, wherein the duration distribution comprises a duration feature from a group consisting of phoneme duration, word duration, utterance duration, and inter-word silence duration.

15. The method of claim 13, wherein the EGG shape value for a period is a slope of a least-squares fitted line from a group consisting of the segment between a glottal closure instant to a maximum value of the period, the segment of the EGG signal when the vocal folds are open, and the segment when the vocal folds are closing.

16. A method for training a donor ranking system comprising:
selecting a donor and a target speaker, having vocal characteristics, from a training database of speech samples;
deriving an actual subjective quality value;
extracting one or more acoustical features from a donor voice speech sample and a target speaker voice speech sample;
supplying the one or more acoustical features to an adaptive system;
predicting a predicted subjective quality value using the adaptive system;
calculating an error value between the predicted subjective quality value and the actual subjective quality value; and
adjusting the adaptive system based on the error value.

17. The method of claim 16, wherein the deriving an actual subjective quality value comprises:
converting the donor voice speech sample to a converted voice speech sample having the vocal characteristics of the target speaker;
providing the converted voice speech sample and the target speaker voice speech sample to a subjective listener; and
receiving the actual subjective quality value from the subjective listener.

18. The method of claim 17, wherein the subjective listener comprises a plurality of constituent listeners and the actual subjective quality value is a statistical combination of constituent quality values received from each of the constituent listeners.

19. The method of claim 18, where in the statistical combination is an average.

20. The method of claim 17, wherein the one or more acoustical features are selected from a group consisting of LSF distance, the rank-sum of a duration distribution, the rank-sum of a pitch distribution, the rank-sum of an energy distribution comprising a plurality of frame-by-frame energy values, the rank-sum of a distribution of spectral tilt values, the rank sum of a distribution of per period open quotient values of an EGG signal period, the rank-sum of a distribution of period-to-period jitter value, the rank-sum of a distribution of period-to period shimmer value, the rank-sum of a distribution of soft phonation indices, the rank sum of a distribution of frame-by frame amplitude differences between first and second harmonics, the rank sum of a distribution of a period-by-period EGG shape value, and a combination thereof.

21. The method of claim 20, wherein the duration distribution comprises a duration feature from a group consisting of phoneme duration, word duration, utterance duration, and inter-word silence duration.

22. The method of claim 20, wherein the EGG shape value for a period is a slope of a least-squares fitted line from a group consisting of the segment between a glottal closure instant to a maximum value of the period, the segment of the EGG signal when the vocal folds are open, and the segment when the vocal folds are closing.
